(19) United States
(12) Patent Application Publication
(10) Pub. No.: US 2009/0179492 A1
(43) Pub. Date: Jul. 16, 2009

(54) PLUGGABLE OPTICAL TRANSCEIVER WITH FUNCTION TO BE PROVIDED WITH POWER SUPPLIES SIMULTANEOUSLY

(75) Inventor: Hiroto ISHIBASHI, Yokohami-shi (JP)

Correspondence Address: VENABLE LLP, P.O. BOX 34385, WASHINGTON, DC, 20043-9998, US

(73) Assignee: SUMITOMO ELECTRIC INDUSTRIES, LTD., Osaka (JP)

(21) Appl. No.: 12/349,175

(22) Filed: Jan. 6, 2009

(30) Foreign Application Priority Data
Jan. 10, 2008 (JP) 2008-002621

(51) Int. Cl. H02J 4/00; H04B 10/00

(52) U.S. Cl. 307/43; 398/135

(57) ABSTRACT

A pluggable optical transceiver is disclosed, in which the transceiver includes first and second circuit blocks. The first circuit block is powered by the first power supply in the host system via a first switch, while the second circuit block is powered by the second power supply also in the host system via a second switch. The first and second switches turn on in the same time even when the first and second power supplies in the host system become active sequentially with a time lag.

### BACKGROUND OF THE INVENTION

1. Field of the Invention

The present invention relates to an optical transceiver with functions of light-transmitting and light-receiving.

2. Related Prior Art

A multi-source agreement (MSA) concerning to a type of an optical transceiver called as small form factor pluggable (SFP) has ruled that the SFP transceiver provides a transmitter unit and a receiver unit each supplied with a power supply, VccR for the receiver unit or VccT for the transmitter unit, independent to each other in order to suppress the noise originating from the transmitter unit affecting the receiver unit. A commercially available IC applicable to the optical transceiver implements a monitor unit common to the transmitter unit and the receiver unit, thus, the transmitter unit is electrically coupled with the receiver unit through the monitor unit.

Assuming a condition when the power supply VccR for the receiver unit is firstly set ahead of the other power supply VccT for the transmitter unit, a current may be provided from the receiver unit through the monitor unit, which may cause a latch-up in the transmitter unit. The present invention is to provide an optical transceiver with a function to provide the electrical power to both the receiver unit and the transmitter unit in the same time even when they are supplied with a time lag.

### SUMMARY OF THE INVENTION

The optical transceiver according to the present invention comprises is pluggable into the host system and is powered by the host system when it is plugged therein. The optical transceiver comprises a first circuit block powered by the first power supply in the host system and a second circuit block powered by the second power supply in the host system. The optical transceiver further comprises a first switch inserted between the first power supply and the first circuit block, and second switch inserted between the second power supply and the second circuit block. A feature of the present optical transceiver is that the first switch is driven by the second power supply and the second switch is driven by the first power supply.

The optical transceiver has switches configured above, two switches may turn on at the same time, by the timing when one of two power supplies is lastly activated even when the first and second power supplies become active sequentially, that is, two switches turn on in different timings. The first circuit block may include a Tx unit, a Tx controller and a transceiver, while, the second circuit block may include an Rx unit and an Rx controller. Because two switches turn on at the same time, circuits included in respective circuit blocks do not latch-up.

### BRIEF DESCRIPTION OF DRAWINGS

FIG. 1 is a block diagram of an optical transceiver according to an embodiment of the present invention; and

FIG. 2 shows a time charts to explain a sequence of activating the power for the optical transceiver.

### DESCRIPTION OF PREFERRED EMBODIMENTS

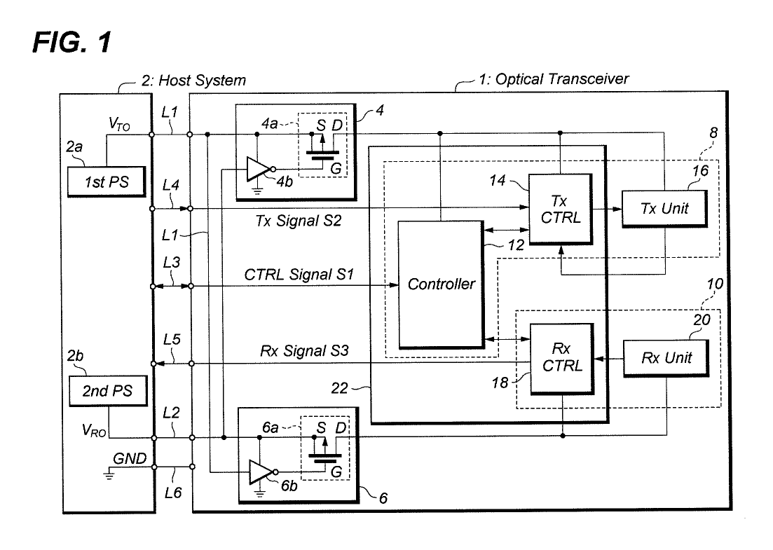

Next, preferred embodiments according to the present invention will be described as referring to accompanying drawings. In the description of the drawings, the same numerals or the same symbols will refer to the same elements without overlapping explanations. FIG. 1 illustrates a block diagram of an optical transceiver according to an embodiment of the invention. The optical transceiver 1 has a configuration that is connected with the host system 2 in pluggable to communicate with the host system 2. The transceiver 1 includes the first switch 4, the second switch 6, the first circuit block 8 that provides the Tx unit 16, the Tx controller 14 and the transceiver controller 12, and the second circuit block 10 that includes the Rx unit 20 and the Rx controller 18. Two switches, 4 and 6, may comprise a p-type MOSFET, 4a and 6a, and the inverters, 4b and 6b. The switches, 4 and 6, may have a combination of an n-type MOSFET and a booster circuit.

The description below first concentrates an embodiment that the first and second switches, 4 and 6, are comprised of a p-MOSFET. The first switch 4, which is connected between the first power supply 2a in the host system 2 and the first circuit block 8 and is driven by the second power supply 2b, provides or cuts the power from the first power supply 2a to the first circuit block 8. The first switch includes the p-MOSFET 4a and the inverter 4b. Specifically, the source S of the p-MOSFET 4a is coupled with the first power supply 2a via the power line L1. When the transceiver 1 is set in the host system 2, the electrical power V_{TO} is supplied on the power line L1. The gate G of the p-MOSFET is coupled with the second power supply 2b through the inverter 4b, while, the drain D thereof is coupled with the first circuit block 8. Thus, the p-MOSFET 4a may be driven by the second power supply 2b through the inverter 4b.

The second switch 6, which is connected between the second power supply 2b and the second circuit block 10, and is driven by the first power supply 2a, supplies or cuts the electrical power from the second power supply 2b to the second circuit block 10. This second switch 2b also includes a p-MOSFET 6a and an inverter 6b. The source S of this p-MOSFET 6b is coupled with the second power supply 2b in the host system via the second power line L2. When the transceiver 1 is set in the host system 2, the electrical power V_{RO} is supplied on the second power line L2. The gate G of the p-MOSFET 6b is coupled with the first power supply 2a via the inverter 6b, while, the drain D of the p-MOSFET 6b is coupled with the second circuit block 10. Thus, this p-MOSFET 6b may be driven with the first power supply 2a via the inverter 6b.

The first circuit block 8 includes a transceiver controller 12, a Tx controller 14 and a Tx unit 16. These units, 12 to 14, are provided with the electrical power V_{TO} from the first power supply 2a through the first switch 4. The transceiver controller 12 is also coupled with the host system via the control line L3 to transmit or receive control signal S1. The transceiver control 12, according to the control signal S1, controls the Tx controller 14 and the Rx controller 18. The control line L3 is also activated when the transceiver 1 is installed in the host system 2.

The Tx controller 14 includes the LD-Driver and the APC (Automatic Power Control) circuit, which are not explicitly illustrated in FIG. 1. The LD-Driver and the APC are controlled based on the command sent from the transceiver controller 12. The Tx controller is coupled with the host system 2 via the signal line L4 that carries the Tx signal S2. The Tx controller 14 controls the Tx Unit so as to emit light corresponding to the Tx signal S2 and the magnitude of the emitted light based on the monitored signal sent from the Tx unit 16. The signal line L4 becomes active when the transceiver 1 is installed in the host system 2.

The Tx unit 16 includes a laser diode LD and a monitor photodiode (hereafter denoted as MPD), which are not explicitly appeared in FIG. 1. The LD emits light under the control of the Tx controller 14, while, the MPD outputs a monitored signal that indicates the magnitude of the light emitted from the LD to the Tx controller 14.

The second circuit block 10 comprises the Rx controller 18 and the Rx unit 20, which are driven by the power V_{RO} supplied form the second power supply 2b in the host system 2 via the second switch 6. The Rx controller 18 includes a limiting amplifier (hereafter denoted as LIA) and an alarm generator, which are not explicitly illustrated in FIG. 1. The alarm generator generates, for instance, a loss-of-signal (hereafter LOS) alarm. The Rx controller 18 generates an Rx signal S3 corresponding to the optical signal received by the Rx unit 20. The Rx controller is coupled with the host system 2 via the signal line L5 to carry the Rx signal S3 thereon. This signal line L5 also becomes active when the transceiver 1 is installed in the host system 2.

The transceiver controller 12, the Tx controller 14 and the Rx controller 18 may be built within a single integrated circuit 22. The housing of the transceiver 1 is grounded in the host system 2 via the ground line L6 which also becomes active when the transceiver 1 is installed in the host system 2.

Next, the operation of the first and second switches, 4 and 6, will be explained in detail. The first switch 4 turns on only when the following conditions are satisfied, that is: (a) both power supplies, 2a and 2b, become active, (b) the source S of the MOSFET 4a receives the power V_{TO} and (c) the gate G thereof receives the low level signal. Under such a condition, the power V_{TO} is provided to the first circuit block 8 from the drain D of the MOSFET 4a. While, when only one of the power supplies, 2a or 2b, is inactivated, where the MOSFET becomes tuned off, the first circuit block 8 is not supplied with the power. That is, when the first power supply 2a is active, while, the second one 2b is inactive, because the input of the first inverter 6a is just the second power supply 2a in spite of the power of the first inverter 4b becomes active, the output of the first inverter 4b is held high which is equivalent to a condition where the gate bias of the first p-MOSFET 4a is held substantially low (Vgs˜0) to turn off the p-MOSFET 4a. Thus, the power V_{TO} provided from the first power supply 2a is not reflected in the drain D of the p-MOSFET 4a. When the first power supply 2a is inactive and the second power supply 2b becomes active, the output of the first switch 4 is left inactive independent of the gate bias of the first MOSFET 4a because the power V_{TO} is inactive at the beginning.

The second switch 6 turns on only when the conditions below are satisfied: that is; (a) the first and second power supplies, 2a and 2b, are both active, (b) the source S of the second p-MOSFET 6a receives the power V_{RO}, and (c) the gate G of the second p-MOSFET 6a becomes low level. Under such a condition, the power V_{RO} may be provided to the second circuit block 10. However, when at least one of the power supplies, 2a or 2b, is inactive, the second p-MOSFET 6a may isolate the power V_{RO} from the second circuit block 10. The second inverter 6b in the second switch 6 operates in a manner similar to the first inverter 4b.

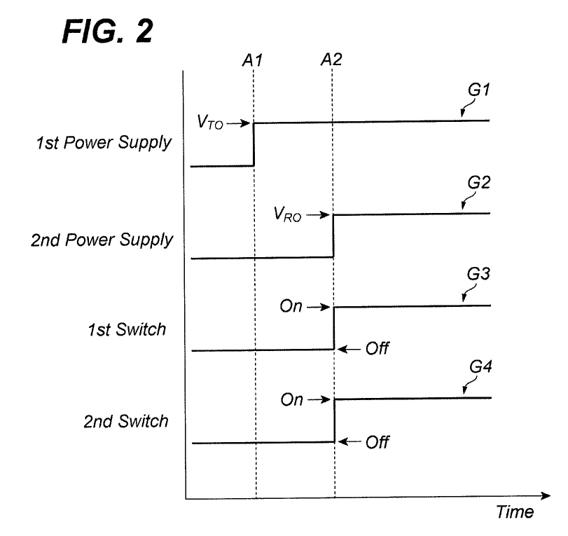

Next, the operation of the first and second switches, 4 and 6, will be specifically described as referring to FIG. 2. Time charts G1 to G3 in FIG. 2 correspond to the operation of the first power supply 2a, that of the second power supply 2b, the power supplied to the first circuit block 8 via the first switch 4, and the power supplied to the second circuit block 10 via the second switch 6, respectively.

When only the first power supply 2a becomes active to generate the voltage V_{TO} at the timing A1 from a state when the both power supplies are inactive, this voltage V_{TO} is applied to the source S of the first MOSFET 4a and the input of the second inverter 6b. Under such a condition, both the first and the second switches are held off and the voltages, V_{TO} and V_{RO}, are not supplied to the first and second circuit blocks, 8 and 10. Subsequently, when the second power supply 2b becomes active at the timing A2 to provide the voltage V_{RO} to the source S of the second p-MOSFET 6a and the input of the first inverter 4a, both of the first and second switches turn on to supply the voltage V_{TO} to the first circuit block 8 and the voltage V_{RO} to the second circuit block 10 at the same time.

Thus, the first and second switches, 4 and 6, may turn on at the same time when the both power supplies become active even if the first power supply 2a and the second power supply 2b has a time lag to be activated. The first circuit block 8 is provided with the power from the first power supply 2a and the second circuit block 10 is provided with the power from the second power supply 2b at the same time.

Although the embodiment described above concentrates on a condition where the switch, 4 or 6, provides the p-MOSFET, 4a or 6a, and the inverter, 4b or 6b, the invention is not restricted to such devices For instance, the switch may provide an n-MOSFET and a booster instead of the inverter, 4b or 6b, to drive the gate of the n-MOSFET.

The booster in the first switch 4 is powered by the first power supply 2a. Assuming a case when the first power supply 2a becomes active, while, the second one 2b is still held inactive, because the input of the first booster in the first switch is still held low even though the drain D of the n-MOSFET in the first switch 4 receives the voltage V_{TO} from the first power supply 2a, the gate G of the n-MOSFET is still kept low, which leaves the n-MOSFET turned off to prevent the voltage V_{TO} from being supplied to the first circuit block 8. Activating the second power supply 2b, the input of the first booster in the first switch 4 becomes high and so does the output of the first booster, to turn on the first n-MOSFET in the first switch 4, which may supply the voltage V_{TO} to the first circuit block 8. At the same time, the drain D of the second n-MOSFET in the second switch 6 and the power of the second booster in the second switch 6 becomes active, which also turns on the second n-MOSFET to supply the voltage V_{RO} to the second circuit block 10.

While the preferred embodiments of the present invention have been described in detail above, many changes to those embodiments may be made without departing from the true scope and teachings of the present invention. The present invention, therefore, is limited only as claimed below and the equivalents thereof.

I claim:

1. A pluggable optical transceiver powered by a host system when said pluggable optical transceiver is installed in said host system, said host system providing a first power supply and a second power supply, said optical transceiver comprising:
a first circuit block powered by said first power supply in said host system;
a second circuit block powered by said second power supply in said host system;
a first switch inserted between said first power supply and said first circuit block; and
a second switch inserted between said second power supply and said second circuit block,
wherein said first switch is driven by said second power supply, and said second switch is driven by said first power supply.

2. The optical transceiver according to claim 1,
wherein said first switch and said second switch each provides a p-MOSFET and an inverter to drive said p-MOSFET, and
wherein said inverter in said first switch is driven by said second power supply and said inverter in said second switch is driven by said first power supply.

3. The optical transceiver according to claim 1,
wherein said first circuit block includes a Tx controller, a Tx unit and a transceiver controller, and
wherein said second circuit block includes an Rx controller and an Rx unit.

4. The optical transceiver according to claim 1,
wherein said first switch and said second switch each provides an n-MOSFET and a booster to drive said n-MOSFET, and
wherein said booster in said first switch is driven by said second power supply and said booster in said second switch is driven by said first power supply.
